(19) United States
(12) Patent Application Publication
(10) Pub. No.: US 2006/0239798 A1
(43) Pub. Date: Oct. 26, 2006

(54) Bus bar contact and fixing device

(76) Inventors: Philippe Chantrel, Pontarlier (FR); Franck Mougin, Libercourt (FR)

Correspondence Address: HARRINGTON & SMITH, LLP, 4 RESEARCH DRIVE, SHELTON, CT, 06484-6212, US

(21) Appl. No.: 10/528,766

(22) PCT Filed: Sep. 11, 2003
(86) PCT No.: PCT/FR03/50050

§ 371 Date: May 5, 2006

(30) Foreign Application Priority Data
Sep. 24, 2002 (FR) 02 11807

(51) Int. Cl. F16B 43/02

(52) U.S. Cl. 411/546

(57) ABSTRACT

Fastening and contact device to be mounted on a plate provided with bus bars, said device including a sleeve and a ring to be mounted through an opening of the plate. The sleeve includes shoulders that come to rest on a first side of the plate, while the ring slides along the sleeve until it comes into contact with a second side of the plate. The plate is clamped between the sleeve and the ring when a tightening means cooperates with the sleeve and a complementary device to which the plate is connected.

The object of the present invention is a fastening and contact device for bus bars, also called “busbars” by the person skilled in the art. It is notably used in the field of connections to be provided in electrical distribution systems using conductive plates of bus bars, and, in particular, in the field of electrical connections designed to transmit high currents in the “bus bar” system. The interest of the invention is to propose a fastening device of small profile that guarantees a good retention of the device on the bus bar conductive plate.

From the teaching of the prior art, a contact clip for a bus bar system is known, described in the document FR-A-2,784,241. This contact clip permits fastening a conductive sleeve onto a bus bar conductive plate. In fact, the plate has an opening through which the sleeve is inserted. This sleeve comprises shoulders preferentially extending parallel to the plane of the plate and therefore orthogonal to the insertion axis of the sleeve into the opening. These shoulders comes to rest against the periphery of the opening. In order to hold this sleeve in position, a ring having an inner surface opening onto an annular cavity is disposed on a second side of the plate, opposite the first side against which the shoulders are supported. This annular cavity cooperates with tabs cut into the sleeve wall. These tabs form elastic clips that can be inserted into the annular cavity. The dimensions of this ring and the position of the tabs are such that the conductive plate is finally retained between the ring and the shoulders of the sleeve.

The problem posed by such retaining clips is that they are made of two fragile pieces that are very highly worked. Moreover, such a contact clip for permitting the conductive plate to be connected with other complementary devices necessitates the presence of a second fastening means, in addition to the one provided to hold the clip on the plate. This second fastening means is generally a screw that passes through the passage of the sleeve and the screw head come to rest against the periphery of the passage formed in the sleeve. This screw passes through the passage and cooperates with a threading provided in the complementary device to be connected with the bus bar plate.

Fastening and contact devices mounted on conductive bus bar plates pose a problem. In fact, on the one hand, the means for holding this contact device on the plate is complex, and finally it is necessarily thick and bulky, because the screw head of the second fastening means for the conductive plate to the complementary device is much larger than the first fastening means. In fact, the first fastening means implements a set of elastic tabs provided to cooperate with a ring. Since these elastic tabs are cut into the wall of the sleeve, the only stress that this screw head can exert on the wall must be applied at the level of the edge of the periphery of the channel, i.e., by increasing the height of the device.

In addition, the structure of the sleeve having elastic tabs to conduct the bus bar current in the direction of a complementary device is such that when the connection is subjected to physical shocks, the quality of the electrical contacts established is not assured with the same regularity. In fact, during these shocks, the contact surface decreases, and consequently, the contact resistance increases, which attenuates the signal transmission.

The object of the invention is to provide a solution to the problems posed above by providing a contact and retaining device having means for being held on a conductive bus bar plate, and for assuring the connection of such a plate with a complementary device while respecting the dimensional and environmental constraints, and while guaranteeing good quality of contact. For this purpose, the invention provides for utilizing a device held mechanically in a simple manner by means of an opening in the plate. This device principally comprises a sleeve provided with shoulders for coming to rest against a periphery of the opening of a first side of the plate. It also comprises a ring with a diameter slightly greater than that of the sleeve. The ring can slide along the sleeve to come to rest on the periphery of the same opening, but of the second side of the plate. The plate is thus clamped between the two elements.

These two elements are held together by the expedient of a tightening means, for example a screw. This screw cooperates directly with the inner wall of a sleeve passage, and also with a threading made in the body of a complementary device with which the plate must be connected. The cooperation of the screw with the inner wall can be translated by supporting the head of this screw against the reliefs formed in the inner wall, and/or even by the cooperation between the threading of the screw and a threading on the inner wall of said sleeve.

The ring is held by this tightening means between the plate against which it is supported on one side, and the complementary device, which is held by the screw, on the other side. The dimensions and length of the ring correspond to the lengthwise dimension of the sleeve, the length of the sleeve being considered between the flat part of the shoulder and the opposite open end.

The object of the invention is a fastening and contact device to be mounted by means of an opening in a conductor that is in the form of a plate, this device comprising a sleeve inserted into the opening, and such that the sleeve has shoulders so as to come to rest on a periphery of the opening of a first side of the plate, characterized in that it comprises a ring mounted around said sleeve, this ring coming to rest against the periphery of the opening of a second side of the plate, and in that the sleeve and the ring are held in contact with the plate by a tightening means cooperating with the sleeve and a complementary device to be connected to the conductor.

The invention will be better understood upon reading the description that follows and upon examining the figures that accompany it. These figures are presented only by way of example and do not at all limit the invention. The figures show:

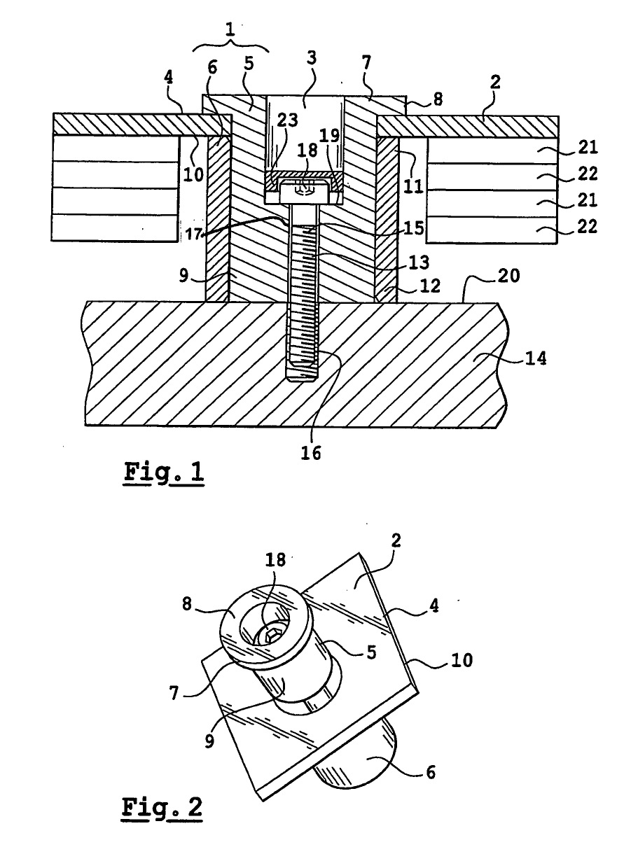

FIG. 1: A cross-sectional view of a fastening and contact device according to the invention mounted on a plate;

FIG. 2: An exploded top view of the device according to the invention before mounting on a plate.

FIG. 1 shows a fastening and contact device 1 mounted on a conductive plate 2. Device 1 is mounted by means of an opening 3 formed in a plate 2. Plate 2 is preferably a conductive plate provided with bus bars. For example, these bus bars are present on an upper face 4 of plate 2.

Device 1 comprises a sleeve 5 and a ring 6. Sleeve 5 is preferably tubular so as to cooperate with opening 3, which is circular in this case. The outer diameter of sleeve 5 is slightly smaller than the inner diameter of opening 3. Sleeve 5 is inserted into opening 3 along an insertion axis orthogonal to the plane formed by plate 2.

Sleeve 5 additionally comprises a shoulder 7 extending radially to the insertion axis. This shoulder 7 locally confers a wider outer diameter to sleeve 5. At the level of this shoulder 7, the outer diameter of the sleeve 5 is clearly greater than the inner diameter of opening 3. Consequently, since sleeve 5 is inserted into opening 3 from upper face 4, shoulder 7 comes to rest on the periphery of opening 3 on the side of the upper face 4. For example, this shoulder 7 can take the form of a collar, as shown in FIG. 2. This collar forms a flat ring with a wide edge that projects radially outwardly at the level of a first end 8 of sleeve 5.

Ring 6 can slide along the wall of sleeve 5. In the example described, ring 6 is of tubular form, and has an inner diameter slightly larger than the outer diameter of sleeve 5. Once sleeve 5 is inserted into opening 3, a second end 9 of sleeve 5 projects from the side of lower face 1 0 of plate 2. Ring 6 is provided so as to be inserted around sleeve 5 by inserting it from the second end 9. Thus a border of a first end 11 of ring 6 comes to rest against upper face 10. In the case where the ring is tubular, ring 6 provides a circular support around opening 3.

Preferably, the width of shoulder 7 is such that the circular support zone of ring 6 is found facing the support zone of shoulder 7. Plate 2 is wedged between shoulder 7 of sleeve 5 and ring 6. When plate 2 is thus disposed, from the side of lower face 10, ring 6 and the sleeve extend orthogonally to plate 2 and respectively have the same length. In fact, second end 9 of sleeve 5 is flush in the same plane as second end 12 of ring 6. Second end 12 is opposite to the first end 11, and is the part of ring 6 furthest from plate 2.

In order to assure the clamping of plate 2 between sleeve 5 and ring 6, device 1 has a means for bringing together and fastening these two elements to one another. In fact, it has a tightening means 13 in order to cooperate with sleeve 5 and a complementary device 14 with which plate 2 must be connected. The connection is assured by means of the conductive parts made up of sleeve 5 and ring 6. In fact, sleeve 5 and ring 6 can be obtained by machining or stamping a conductive material such as copper.

Tightening means 13 comprises a threaded body 15 provided to cooperate with at least one complementary threading 16 provided in complementary device 14. Thus, tightening means 13 is mechanically held on complementary device 14. Tightening means 13 also cooperates with sleeve 5. Sleeve 5 has a passage 17 so as to receive a portion of tightening means 13 therein.

In a first embodiment, tightening means 13 comprises a threaded body 15 such that the screw pitch is presented at the level of passage 17 to cooperate with threaded body 15.

In a second embodiment, tightening means 13 comprises a screw head 18. This screw head 18 passes into passage 17. In this case, passage 17 is open at both ends, 8 and 9, respectively. Screw 13 is then inserted from end 8 into passage 17. Moreover, this passage 17 also comprises a stop 19 at the level of the inner wall of passage 17. Head 18 then comes to abut against this stop 19 and only the threaded body 15 projects out from the side of second end 9. According to this second embodiment, sleeve 5 can nevertheless also have a threaded portion in order to cooperate with threaded body 15.

When sleeve 5 is held on complementary device 14, then the second end 9 rests against a surface 20 of this device 14, surface 20 in which the complementary threading 16 is formed. Moreover, given the respective lengths of sleeve 5 and ring 6, ring 6 also comes to rest against this surface 20. By turning tightening means 13, sleeve 5 is moved closer to complementary device 14, but given the height of ring 6, this operation leads to the clamping of plate 2.

Moreover, plate 2 can be formed of a superimposition of successive insulating layers such as 21 and conductive layers such as 22. This structure does not harm the connection made with device 1. In fact, plates such as 22, since they do not need to be connected by device 1, are not connected and they have a clearly wider opening such as 3, thus permitting sleeve 5 and ring 6 to be mounted without having to contact them. The length of ring 6 is such that it is greater than the thicknesses of layers 21 and 22 superimposed on one another. Moreover, the length of sleeve 5 is such that it is just slightly greater relative to the length of ring 6 for accommodating the thickness of plate 2.

By means of the invention, a device 1 can be proposed with dimensions adapted to the number of superimposed layers 2, 21 and 22, and also to limit the space required for the upper face 4 of plate 2.

In one particular embodiment of the invention, in the case where the tightening means comprises a screw head 18, device 1 can comprise a retaining piece 23 to cooperate with the geometry of screw head 18 and the inner geometry of the inner wall of sleeve 5 to prevent undesired rotations.

1. A fastening and contact device to be mounted by means of an opening in a conductor that is in the form of a plate, said device comprising a sleeve inserted into the opening, and such that the sleeve comprises shoulders that come to rest on a periphery of the opening of a first side of the plate, characterized in that it comprises a ring mounted around the sleeve, this ring coming to rest against the periphery of the opening of a second side of the plate, and in that the sleeve and the ring are held in contact with the plate by a tightening means cooperating with the sleeve and a complementary device to be connected to the conductor.

2. The device according to claim 1, further characterized in that the sleeve has a passage provided with a threading in order to cooperate with the tightening means.

3. The device according to claims 1, further characterized in that the passage comprises a stop defining a place for receiving a screw head.

4. The device according to claim 3, further characterized in that it comprises a retaining piece to cooperate with the geometry of the screw head and the inner geometry of the second part in order to impede the rotation of the screw.

5. The device according to claims 1, further characterized in that the sleeve is cylindrical, that the opening is circular and that the shoulders form a thin collar projecting out on the first side of the plate.

6. The device according to claims 1, further characterized in that at least one additional conductive layer or insulating layer of the conductor is disposed on the second side of the plate, and in that the length of the ring is defined as a function of the thickness of the additional layer.

7. The device according to one of claims 1, further characterized in that the conductor is a conductive plate provided with bus bars.
